(19) United States
(12) Patent Application Publication
(10) Pub. No.: US 2019/0077371 A1
(43) Pub. Date: Mar. 14, 2019

(54) GPS-Enabled Key Fob with Voice Capability

(71) Applicant: Daphne Gaither, Bedford, OH (US)

(72) Inventor: Daphne Gaither, Bedford, OH (US)

(21) Appl. No.: 15/464,308

(22) Filed: Mar. 20, 2017

(51) Int. Cl. B60R 25/24; H04W 4/04; H04W 4/22; B60R 25/102

(52) U.S. Cl. CPC B60R 25/24; B60R 25/102; H04W 4/22; H04W 4/046

(57) ABSTRACT

A GPS-enabled key fob with voice capability that is adapted to enable drivers to locate their vehicle. The GPS-enabled key fob with voice capability includes a voice button disposed on the front facing of the casing, the voice button adapted to activate a voice activated system that may adapted to provide directions where a vehicle is located, wherein the voice button is adapted to depress for a predetermined period of time to activate a global positioning system adapted to locate the vehicle. The GPS-enabled key fob with voice capability also includes a disable button that is adapted to depress to indicate via the voice activated system how far the vehicle is away and that the vehicle is not where it was originally parked.

### BACKGROUND OF THE INVENTION

### Field of the Invention

The present invention is a GPS-enabled key fob. More specifically, the present invention is a GPS-enabled key fob with voice capability.

### Description of the Related Art

Utilizing the latest global positioning technology, drivers activating a GPS-enabled key fob to track the location of their parked vehicle can be a difficult task. Ideal for people that have trouble locating their car in a parking lot, garage or street, the GPS-enabled key fob with voice capability helps drivers navigate to their car with turn-by-turn directions to the vehicle's location.

What is needed is a GPS-enabled key fob with voice capability that enables drivers to locate their vehicle.

### SUMMARY OF THE INVENTION

The present invention is a GPS-enabled key fob. More specifically, the present invention is a GPS-enabled key fob with voice capability.

The GPS-enabled key fob with voice capability includes a casing having a front facing, a first end and a second end, a voice button disposed on the front facing of the casing, the voice button activates a voice activated system that may provide directions where a vehicle is located, a lock button depressed to lock all of a plurality of vehicle doors and an unlock button depressed to unlock all of the vehicle doors. The GPS-enabled key fob with voice capability also includes a disable button depressed to disable the vehicle, an emergency button depressed to notify a police department or a GPS emergency assistant to come to aid a driver, a flashlight disposed on the first end of the casing to provide light on a desired area and a handle disposed on the second end of the casing to grasp and facilitate transporting the GPS-enabled key fob with voice capability.

It is an object of the present invention to provide a GPS-enabled key fob with voice capability that enables drivers to locate their vehicle.

It is an object of the present invention to provide a GPS-enabled key fob with voice capability that features a voice enabled key fob with a built-in GPS which effortlessly connects to one's vehicle for improved utilization.

It is an object of the present invention to provide a GPS-enabled key fob with voice capability that is designed to be manufactured in a variety of colors to meet any consumer preference.

It is an object of the present invention to provide a GPS-enabled key fob with voice capability that is used as a deterrent from auto thefts for versatile functionality.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a GPS-enabled key fob with voice capability, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

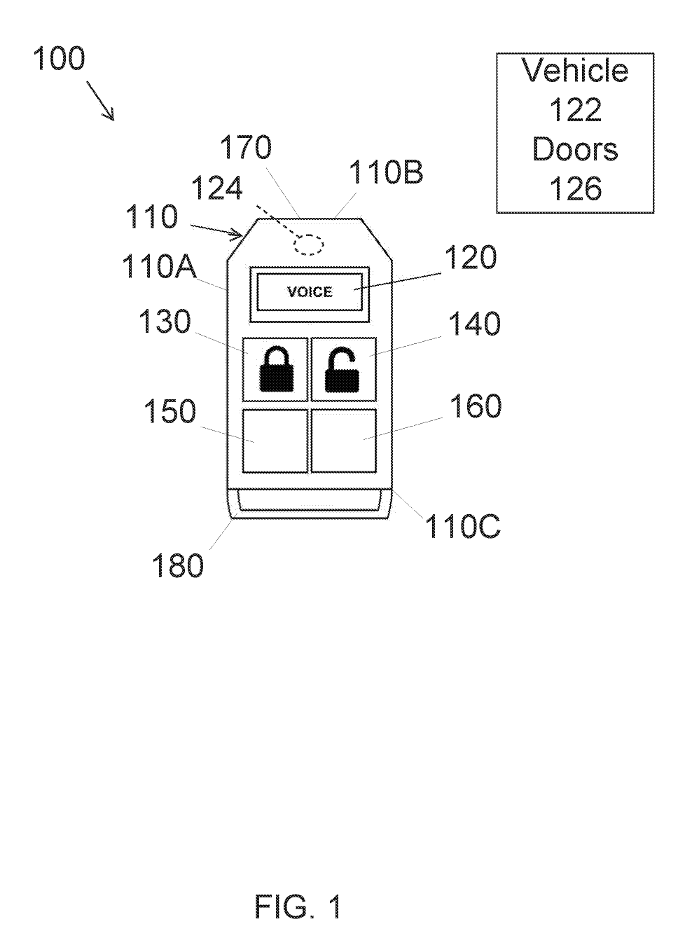

FIG. 1 illustrates a GPS-enabled key fob with voice capability 100, in accordance with one embodiment of the present invention.

The GPS-enabled key fob with voice capability 100 may include a casing 110, a voice button 120, a lock button 130, an unlock button 140, a disable button 150, an emergency button 160, a flashlight 170 and a handle 180.

The casing 110 may include a front facing 110A, a first end 110B and a second end 110C. The casing 110 may be made of material selected from the group consisting of metal, plastic, polymer or other suitable material. The voice button 120 may be disposed on the front facing 110A of the casing 110. The voice button 120 may be adapted to depress for a predetermined period of time such as approximately three seconds or other suitable predetermined period of time that is adapted to activate a global positioning system or GPS to locate a vehicle 122. The voice button 120 may be adapted to activate a voice activated system 124 that may provide directions where the vehicle 122 is located. The lock button 130 may be adapted to depress to lock all of a plurality of vehicle doors 126. The unlock button 140 may be adapted to depress to unlock all of the vehicle doors 126. The disable button 150 may be adapted to depress to indicate via the voice activated system 124 how far the vehicle 122 is away, that the vehicle 122 is not where it was originally parked or to disable the vehicle 122. The emergency button 160 may be adapted to depress to contact a police department or a GPS emergency assistant to locate the vehicle 122 or notify them to come to aid a driver. The voice button 120, the lock button 130, the unlock button 140, the disable button 150 and the emergency button 160 may be adapted to illuminate when depressed to indicate that the voice button 120, the lock button 130, the unlock button 140, the disable button 150 and the emergency button 160 have been activated. The flashlight 170 may be disposed on the first end 110B of the casing 110 that is adapted to provide light on a desired area. The handle 180 may be disposed on the second end 110C of the casing 110 to be adapted to grasp and facilitate transporting the GPS-enabled key fob with voice capability 100.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

1. A GPS-enabled key fob with voice capability, comprising:
a casing having a front facing, a first end and a second end;
a voice button disposed on the front facing of the casing, the voice button adapted to activate a voice activated system that may be adapted to provide directions where a vehicle is located;
a lock button disposed on the front facing of the casing, the lock button adapted to be depressed to lock all of a plurality of vehicle doors;
an unlock button disposed on the front facing of the casing, the unlock button adapted to be depressed to unlock all of the vehicle doors;
a disable button disposed on the front facing of the casing, the disable button adapted to be depressed to disable the vehicle;
an emergency button disposed on the front facing of the casing, the emergency button adapted to be depressed to notify a police department or a GPS emergency assistant to come to aid a driver;
a flashlight disposed on the first end of the casing adapted to provide light on a desired area; and
a handle disposed on the second end of the casing adapted to grasp and facilitate transporting the GPS-enabled key fob with voice capability.

2. The GPS-enabled key fob with voice capability according to claim 1, wherein the casing is made of material selected from the group consisting of metal, plastic or polymer.

3. The GPS-enabled key fob with voice capability according to claim 1, wherein the voice button is adapted to be depressed for a predetermined period of time to activate a global positioning system adapted to locate the vehicle.

4. The GPS-enabled key fob with voice capability according to claim 3, wherein the predetermined period of time is three seconds.

5. The GPS-enabled key fob with voice capability according to claim 1, wherein the disable button is adapted to be depressed to indicate via the voice activated system how far the vehicle is away.

6. The GPS-enabled key fob with voice capability according to claim 1, wherein the disable button is adapted to be depressed to indicate that the vehicle is not where it was originally parked.

7. The GPS-enabled key fob with voice capability according to claim 1, wherein the emergency button is adapted to be depressed to contact the police department to locate the vehicle.

8. The GPS-enabled key fob with voice capability according to claim 1, wherein the voice button, the lock button, the unlock button, the disable button and the emergency button are adapted to illuminate when depressed to indicate that the voice button, the lock button, the unlock button, the disable button and the emergency button have been activated.
